(19) United States
(12) Patent Application Publication
(10) Pub. No.: US 2026/0179343 A1
(43) Pub. Date: Jun. 25, 2026

(54) ILLUMINATION SYSTEM AND PALM SCANNING DEVICE

(71) Applicant: Tencent Technology (Shenzhen) Company Limited, Shenzhen (CN)

(72) Inventors: Weibiao ZHOU, Shenzhen (CN); Hui GONG, Shenzhen (CN); Kai XIA, Shenzhen (CN); Runzeng GUO, Shenzhen (CN); Changze XIAO, Shenzhen (CN)

(21) Appl. No.: 19/542,460

(22) Filed: Feb. 17, 2026

Related U.S. Application Data
(63) Continuation of application No. PCT/CN2024/110069, filed on Aug. 6, 2024.

(30) Foreign Application Priority Data
Nov. 15, 2023 (CN) 202323090555.3

(51) Int. Cl. G06V 10/141; G02B 26/08; G02B 26/10; G06F 21/32; G06V 10/145; G06V 40/13

(52) U.S. Cl. CPC G06V 10/141; G02B 26/0833; G02B 26/105; G06F 21/32; G06V 10/145; G06V 40/1318

(57) ABSTRACT

Disclosed are an illumination system and a palm scanning device. The illumination system is used in the palm scanning device, and the illumination system includes an illuminating lamp and a DMD reflector. The DMD reflector is located on an emergent light path of the illuminating lamp. The DMD reflector includes a plurality of pixel reflectors, and angles of the plurality of pixel reflectors are adjustable, to cause a field of view (FOV) of reflected light of the DMD reflector to be adjustable.

### CROSS-REFERENCE TO RELATED APPLICATIONS

The present disclosure is a continuation application of PCT Patent Application No. PCT/CN2024/110069, entitled “ILLUMINATION SYSTEM AND PALM SCANNING DEVICE” filed on Aug. 6, 2024, which claims priority to Chinese Patent Application No. 202323090555.3, entitled “ILLUMINATION SYSTEM AND PALM SCANNING DEVICE” filed on Nov. 15, 2023, both of which are incorporated herein by reference in their entirety.

### FIELD OF THE TECHNOLOGY

The present disclosure relates to the field of electronic device technologies, and in particular, to an illumination system and a palm scanning device.

### BACKGROUND OF THE DISCLOSURE

As convenient payment is increasingly integrated into daily life, various biometric recognition technologies also increasingly enter the field of identity recognition. At present, the palm print and palm vein acquisition and recognition technology also gradually becomes a biometric recognition technology that receives continuous attention, and palm scanning devices have emerged accordingly.

In the related art, the palm scanning device includes an illumination system and a camera. The illumination system includes an illuminating lamp configured to illuminate a palm. The camera captures a palm of a user, to enable the palm scanning device to recognize palm features of the user and then verify an identity of the user.

### SUMMARY

According to a first aspect, the present disclosure provides an illumination system. The illumination system is used in a palm scanning device, and the illumination system includes an illuminating lamp and a digital micromirror device DMD reflector.

The DMD reflector is located on an emergent light path of the illuminating lamp.

The DMD reflector includes a plurality of pixel reflectors. Angles of the plurality of pixel reflectors are adjustable, to cause a field of view (FOV) of reflected light of the DMD reflector to be adjustable.

According to a second aspect, the present disclosure further provides a palm scanning device, including the illumination system according to any one of the first aspect.

### BRIEF DESCRIPTION OF THE DRAWINGS

FIG. 1 is a schematic structural diagram of an illumination system according to an embodiment of the present disclosure.

FIG. 2 is a schematic structural diagram of a DMD reflector according to an embodiment of the present disclosure.

FIG. 3 is a schematic structural diagram of an illumination system according to an embodiment of the present disclosure.

FIG. 4 is a schematic structural diagram of an illumination system according to an embodiment of the present disclosure.

FIG. 5 is a schematic structural diagram of an illumination system according to an embodiment of the present disclosure.

FIG. 6 is a schematic structural diagram of an illumination system according to an embodiment of the present disclosure.

### DESCRIPTION OF REFERENCE SIGNS

1. illuminating lamp;
2. DMD reflector; 21. pixel reflector;
3. distance sensor;
4. controller;
5. camera.

### Description of Embodiments

To make the objectives, technical solutions, and advantages of the present disclosure clearer, the following further describes the implementations of the present disclosure in detail with reference to the accompanying drawings.

Terms used in implementations of the present disclosure are merely configured for explaining embodiments of the present disclosure, and do not intend to limit the present disclosure. Unless otherwise defined, the technical terms or scientific terms used in the implementations of the present disclosure are to have general meanings understood by a person of ordinary skill in the field of the present disclosure. “One” or “a” and similar terms used in the specification of the present disclosure and the claims do not indicate a quantity limitation, but indicate that there is at least one. “Comprising” or “containing” and similar terms mean that the elements or articles appearing before “comprising” or “containing” cover the listed elements or articles appearing after “comprising” or “containing” and equivalents thereof, and do not exclude other elements or articles. “Connection”, “connected”, and similar terms are not limited to a physical or mechanical connection, but may include an electrical connection, regardless of a direct or indirect connection. “Up”, “down”, “left”, “right”, and the like are merely configured for indicating relative positional relationships. After absolute positions of described objects change, relative positional relationships may also change. “A plurality of” means two or more, unless otherwise definitely limited.

As convenient payment is increasingly integrated into daily life, various biometric recognition technologies also increasingly enter the field of identity recognition. At present, the palm print and palm vein acquisition and recognition technology also gradually becomes a biometric recognition technology that receives continuous attention, and palm scanning devices have emerged accordingly.

In the related art, the palm scanning device includes an illumination system and a camera. The illumination system includes an illuminating lamp, configured to illuminate a palm. The camera captures a palm of a user, to enable the palm scanning device to recognize palm features of the user and then verify an identity of the user.

When a user uses the palm scanning device, a distance between a palm of the user and the palm scanning device is not fixed. If the palm is close to the palm scanning device, consequently, light emitted by the illuminating lamp may not cover the entire palm, making it difficult for the camera to obtain clear palm features. If the palm is far from the palm scanning device, light intensity is weakened when light is irradiated on the palm, also making it difficult for the camera to obtain clear palm features.

Therefore, to enable the camera to capture a clear image for subsequent recognition, it is necessary to ensure that the illuminating lamp implements complete coverage on the palm at a close position, that is, to implement large-FOV illumination. It is also necessary to ensure that the illuminating lamp can perform effective brightness compensation on the palm at a far position, that is, to satisfy a high illumination requirement.

However, when an FOV of the illuminating lamp is large, although light of the illuminating lamp covers a large area, brightness per unit area is low. In this case, when the palm is far from the palm scanning device, brightness on a surface of the palm is low, making it difficult for the camera to obtain clear palm features. In addition, when the palm is far from the palm scanning device, a proportion of the FOV occupied by the palm significantly decreases. To be specific, only light from a middle part of the illuminating lamp is irradiated on the palm, while light from an edge part of the illuminating lamp is not irradiated on the palm. Therefore, there is a significant waste of light, resulting in low illumination efficiency of the illumination system.

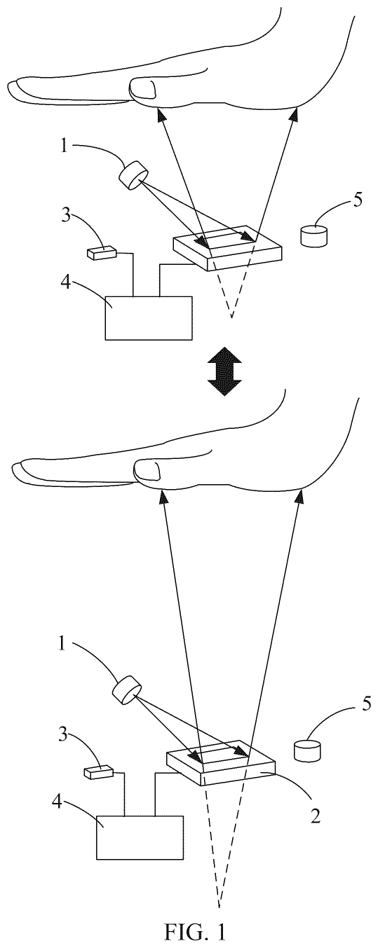

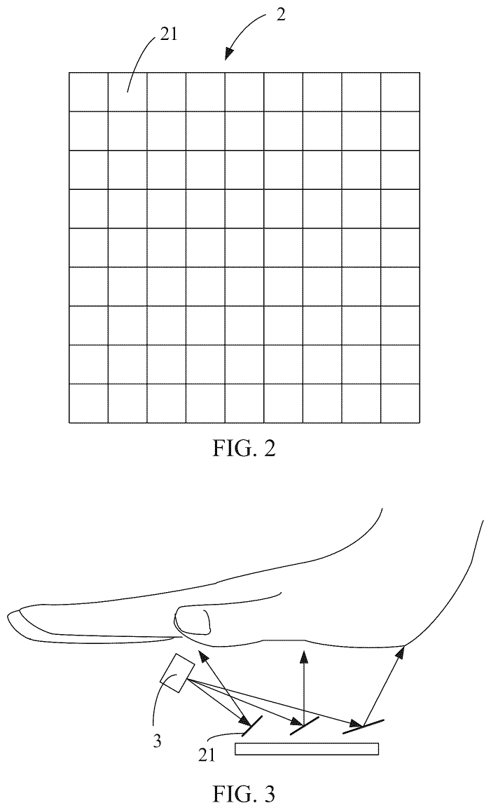

In view of the foregoing technical problems, an embodiment of the present disclosure provides an illumination system, used in a palm scanning device. As shown in FIG. 1 and FIG. 2, the illumination system includes an illuminating lamp 1 and a digital micromirror device (DMD) reflector 2. The DMD reflector 2 is located on an emergent light path of the illuminating lamp 1. The DMD reflector 2 includes a plurality of pixel reflectors 21. Angles of the plurality of pixel reflectors 21 are adjustable (or deflection angles are adjustable), and the plurality of pixel reflectors 21 are configured to reflect light emitted by the illuminating lamp 1 outward.

The DMD reflector 2 is a micro-electro-mechanical system (MEMS) with an electronic input and an optical output. The DMD reflector 2 includes many small aluminum reflective mirrors (the pixel reflectors 21), each of which is referred to as one pixel. The pixel reflectors 21 can rotate at different angles under the control of voltage. For the DMD reflector 2, the pixel reflectors 21, a complementary metal oxide semiconductor (CMOS), and a static random access memory (SRAM) are integrated into a same chip by using a MEMS manufacturing process.

According to the technical solution provided in this embodiment of the present disclosure, the DMD reflector 2 includes the plurality of pixel reflectors 21, and the angle of each pixel reflector 21 is adjustable. Therefore, even if an FOV of the illuminating lamp 1 is fixed and unchanged, an FOV of reflected light of the DMD reflector 2 is adjustable when the illuminating lamp irradiates the DMD reflector 2.

In this way, when a palm is close to the palm scanning device, deflection angles of the pixel reflectors 21 are adjusted to make an FOV of reflected light of the DMD reflector 2 larger, so that the reflected light can cover the entire palm and brightness of light on the palm is uniform. When a palm is far from the palm scanning device, deflection angles of the pixel reflectors 21 are adjusted to make an FOV of reflected light of the DMD reflector 2 smaller, so that light is focused into a smaller region, and further, light intensity is stronger at a position of the palm. Because the palm is far from the palm scanning device, the light can cover the entire palm even at a small FOV, so that brightness of the light on the palm is uniform. In addition, utilization of the light is improved by focusing the light, that is, illumination efficiency of the illumination system is improved, helping reduce power consumption of the palm scanning device.

In view of the above, the FOV of the illumination system provided in this embodiment of the present disclosure is adjustable, so that the palm scanning device can obtain a clear palm image when the palm is close to or far from the palm scanning device.

The illumination system provided in this embodiment of the present disclosure does not directly illuminate the palm with the illuminating lamp 1, but reflects reflected light of the DMD reflector 2 to the palm. Therefore, compared with the related art, the illuminating lamp 1 does not need to have a large FOV In this way, in some examples, the FOV of the illuminating lamp 1 ranges from 20° to 60°, and the FOV of the reflected light of the DMD reflector 2 ranges from 90° to 120°. In this way, light emitted by the illuminating lamp 1 has higher edge brightness, so that brightness is also higher after the light is reflected by the DMD reflector 2, thereby illuminating an edge of the palm.

In some examples, as shown in FIG. 1, the illumination system further includes a distance sensor 3 and a controller 4. The distance sensor 3 is configured to detect a distance from a palm. The controller 4 is electrically connected to the DMD reflector 2 and the distance sensor 3. The controller 4 is configured to adjust the angles of the pixel reflectors 21 based on the distance detected by the distance sensor 3. The distance sensor 3 includes an infrared modulated spectral reflectance intensity detection device or infrared time-of-flight detection device. The distance sensor 3 can detect whether the palm is opposite to the palm scanning device, and measure a distance between the palm and the palm scanning device.

In some examples, as shown in an upper part of FIG. 1, when the distance from the palm detected by the distance sensor 3 is a first distance, the controller 4 adjusts the FOV of the reflected light of the DMD reflector 2 to a first FOV. As shown in a lower part of FIG. 1, when the distance from the palm detected by the distance sensor 3 is a second distance, the controller 4 adjusts the FOV of the reflected light of the DMD reflector 2 to a second FOV The first distance is less than the second distance, and the first FOV is larger than the second FOV.

In this way, when the palm is close to the palm scanning device, the FOV of the reflected light of the DMD reflector 2 is large. When the palm is far from the palm scanning device, the FOV of the reflected light of the DMD reflector 2 is small.

In some examples, the illumination system includes a plurality of distance sensors 3.

The palm is not always directly above the DMD reflector 2. Therefore, by arranging a plurality of distance sensors 3, a position (namely, a spatial position) of the palm can be accurately obtained, thereby enabling the controller 4 to more accurately control the deflection angles of the pixel reflectors 2. The spatial position includes the distance between the palm and the palm scanning device and a distance by which the palm deviates from a central axis of the palm scanning device. For example, a specific position of the palm in an acquisition region of the camera, for example, the middle, upper left, lower left, upper right, or lower right of the acquisition region, can be determined through detection by the plurality of distance sensors 3. The acquisition region is located above the illumination system, and is divided into four regions, the upper left, lower left, upper right, and lower right, by horizontal and vertical coordinate axes.

In some examples, the controller 4 is configured to determine the spatial position of the palm based on distances detected by the plurality of distance sensors 3. The angles of the plurality of pixel reflectors 21 are adjusted based on the spatial position of the palm, to adjust an orientation and the FOV of the reflected light of the DMD reflector 2, thereby enabling the reflected light to better illuminate the palm.

For example, as shown in FIG. 3 to FIG. 5, when it is determined that the palm is located directly above the DMD reflector 2, center light of the reflected light of the DMD reflector 2 is controlled to point directly upward.

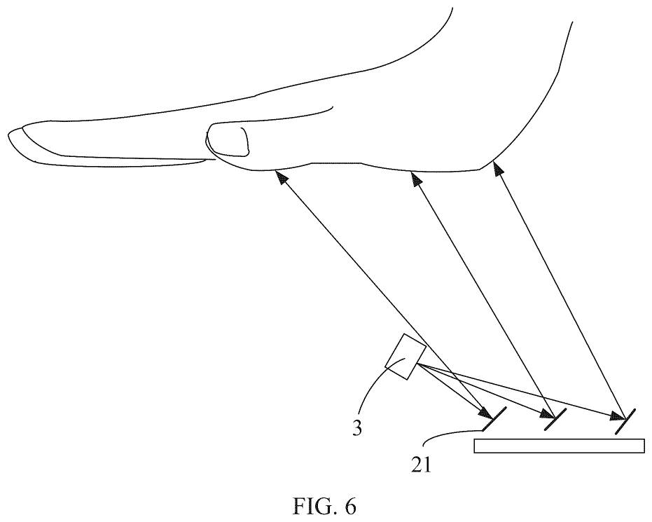

For another example, as shown in FIG. 6, when it is determined that the palm is located above and to the left of the DMD reflector 2, the entire reflected light of the DMD reflector 2 is controlled to reflect upward to the left.

In some examples, as shown in FIG. 2, the plurality of pixel reflectors 21 are arranged in an array, and the deflection angles of the plurality of pixel reflectors 21 are different, to reflect the light to different angles.

As shown in FIG. 3, when the palm is close to the DMD reflector 2, the plurality of pixel reflectors 21 reflect incident light to the palm, and the FOV of the reflected light is large, so that the reflected light can cover the palm.

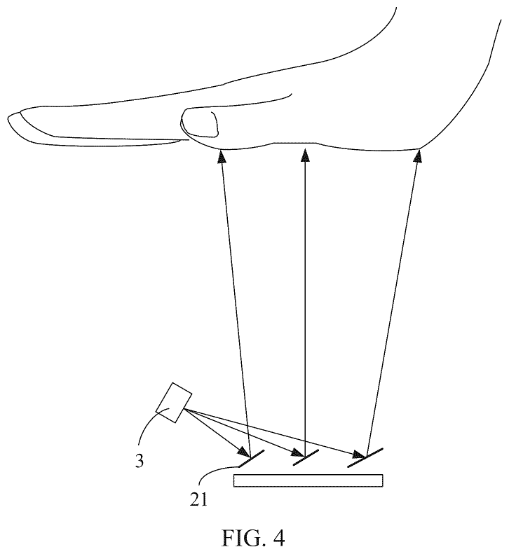

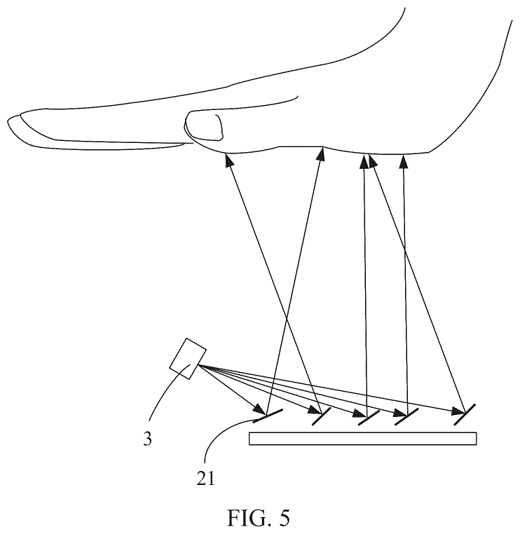

As shown in FIG. 4, when the palm is far from the DMD reflector 2, reflected light of the plurality of pixel reflectors 21 is focused to a center, so that the FOV of the reflected light is small, thereby enhancing light intensity of the light. In this way, the palm can be illuminated with low power consumption.

In addition, as shown in FIG. 5, the plurality of pixel reflectors 21 can also reflect partial light from an edge of the illuminating lamp 1 toward a center of the palm, and reflect partial light from a center of the illuminating lamp 1 toward an edge of the palm, thereby making brightness of the light on the palm more uniform and making the palm clearer.

In some examples, a resolution of the DMD reflector 2 is 1080p. In this way, the DMD reflector 2 can include more pixel reflectors 21, so that the DMD reflector 2 can more accurately adjust the FOV of the reflected light.

Certainly, in some other examples, the resolution of the DMD reflector 2 may be set to another resolution, such as 540p or 720p, based on an actual requirement. This is not specifically limited in this embodiment of the present disclosure.

In some examples, one illuminating lamp 1 is provided. The illuminating lamp 1 does not directly illuminate the palm, and instead, the DMD reflector 2 reflects light emitted by the illuminating lamp 1. In addition, the reflected light of the DMD reflector 2 is uniform. Therefore, there is no need to arrange a plurality of illuminating lamps 1 at a plurality of positions, thereby reducing overall power of the illumination system.

Certainly, in some other examples, a plurality of illuminating lamps 1 may be provided. This is not specifically limited in this embodiment of the present disclosure.

In some examples, the illuminating lamp 1 is a light emitting diode (LED). The LED can emit light of a specific wavelength at a specific angle, and achieve, as driven by different currents and duty cycles, different brightness variations according to an image acquisition need of the camera.

In some examples, the illuminating lamp 1 is an infrared lamp, that is, the illuminating lamp 1 emits infrared light.

In some other examples, the illuminating lamp 1 may alternatively emit visible light, or emit both infrared light and visible light. This is not specifically limited in this embodiment of the present disclosure.

An embodiment of the present disclosure further provides a palm scanning device. As shown in FIG. 1, the palm scanning device includes the foregoing illumination system.

As shown in FIG. 1, the palm scanning device further includes a camera 5. The camera 5 is configured to obtain a palm image.

According to the technical solutions provided in the embodiments of the present disclosure, the FOV of the illumination system in the palm scanning device is adjustable when the illumination system illuminates the palm, so that the palm scanning device (the camera 5) can obtain a clear palm image when the palm is close to or far from the palm scanning device.

The foregoing descriptions are merely some embodiments of the present disclosure, and are not intended to limit the present disclosure. Any modification, equivalent replacement, or improvement made within the principle of the present disclosure shall fall within the protection scope of the present disclosure.

What is claimed is:

1. An illumination system, used in a palm scanning device, the illumination system comprising an illuminating lamp and a digital micromirror device (DMD) reflector,
the DMD reflector being located on an emergent light path of the illuminating lamp; and
the DMD reflector comprising a plurality of pixel reflectors, angles of the plurality of pixel reflectors being adjustable, to cause a field of view (FOV) of reflected light of the DMD reflector to be adjustable.

2. The system according to claim 1, wherein an FOV of the illuminating lamp ranges from 20° to 60°, and the FOV of the reflected light of the DMD reflector ranges from 90° to 1200.

3. The system according to claim 1, further comprising a distance sensor and a controller,
the distance sensor being configured to detect a distance from a palm; and
the controller being electrically connected to the DMD reflector and the distance sensor, and the controller being configured to adjust the angles of the plurality of pixel reflectors based on the distance detected by the distance sensor.

4. The system according to claim 3, wherein when the distance from the palm detected by the distance sensor is a first distance, the controller adjusts the FOV of the reflected light of the DMD reflector to a first FOV; and
when the distance from the palm detected by the distance sensor is a second distance, the controller adjusts the FOV of the reflected light of the DMD reflector to a second FOV,
the first distance being less than the second distance, and the first FOV being larger than the second FOV.

5. The system according to claim 3, comprising a plurality of distance sensors.

6. The system according to claim 5, wherein the controller is configured to determine a spatial position of the palm based on distances detected by the plurality of distance sensors; and
adjust the angles of the plurality of pixel reflectors based on the spatial position of the palm, to adjust an orientation and the FOV of the reflected light of the DMD reflector.

7. The system according to claim 1, wherein the plurality of pixel reflectors are arranged in an array.

8. The system according to claim 1, wherein a resolution of the DMD reflectors is 1080p.

9. The system according to claim 1, wherein one illuminating lamp is provided.

10. The system according to claim 1, wherein the illuminating lamp is a light emitting diode LED.

11. The system according to claim 1, wherein the illuminating lamp is an infrared lamp.

12. A palm scanning device, comprising the system according to claim 1.
